(19) United States
(12) Patent Application Publication
(10) Pub. No.: US 2025/0210245 A1
(43) Pub. Date: Jun. 26, 2025

(54) POWER CONVERTER ASSEMBLY INCLUDING TRANSFORMER

(71) Applicant: Infineon Technologies Austria AG, Villach (AT)

(72) Inventors: Stephen R. Pullen, Olympia, WA (US); Danny R. Clavette, Greene, RI (US)

(21) Appl. No.: 18/390,813

(22) Filed: Dec. 20, 2023

(51) Int. Cl. H01F 27/28; H01F 41/04; H02M 3/00

(52) U.S. Cl. CPC H01F 27/2804; H01F 41/041; H02M 3/003; H01F 2027/2809

(57) ABSTRACT

This disclosure includes a power converter assembly comprising: a stack of multiple circuit layers; multiple transformer windings disposed in the stack of multiple circuit layers, the multiple transformer windings including one or more primary windings and one or more secondary windings; and a first connectivity interface operative to connect the stack of multiple circuit layers to a host substrate. The first connectivity interface may be disposed on a first surface of the stack of multiple circuit layers. The first surface such as edges of the multiple circuit layers may be disposed substantially orthogonal with respect to planar surfaces of each of the multiple circuit layers of the stack to provide advantageous output of an output voltage generated by the power converter assembly to a load such as through the host substrate.

### BACKGROUND

A conventional printed circuit board (PCB) or printed wiring board is a laminated structure of conductive layers separated by insulating layers. In general, PCBs have two functions. The first is to secure electronic components at designated locations on the outer layers by means of soldering. The electronic circuit instantiated by the populated circuit board is designed to provide one or more specific functions. After fabrication, the electronic circuit is powered to perform the desired functions.

Typically, a printed circuit board is a planar device on which multiple components are interconnected via traces to provide the functions as previously discussed. Such implementations of fabricating circuitry on a planar circuit board assembly is dimensionally limited.

Typically power converter designs today utilize VRD circuits from a 12 volt mid voltage from the 48 volts with multiphase circuits to mount to the motherboard/substrate. These present solutions provide a solution from the 12 volt intermediate rail with higher density and efficiency, but these solutions are driven from a combination of a 48 volt input rail to a 12 volt rail and 12 volt to core with a VR module with both losses summed for the total loss.

The conventional 48V to core power converter solutions today are mounted laterally to power the processor and the lateral losses are high as you provide power from the motherboard to the processor core substrate to power the processor since the PDN circuit has extra trace resistance that is higher. The lateral support of power also has much higher inductance in series with the processor which causes higher transients for the processor due to the high di/dt of the current transients that must pass through this series inductance. Efficiency is lower and transient is worsened due to series resistance and inductance. A 48 volt converter to core today is connected laterally with lossy series connection. Higher density is not achieved and transient currents require more capacitance to meet the specification due to the higher series inductance to the load.

### BRIEF DESCRIPTION

Implementation of clean energy (or green technology) is very important to reduce our impact as humans on the environment. In general, clean energy includes any evolving methods and materials to reduce an overall toxicity of energy consumption on the environment.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, etc. Regardless of whether energy is received from green energy sources or non-green energy sources, it is desirable to make most efficient use of raw energy provided by such systems to reduce our impact on the environment. This disclosure contributes to reducing our carbon footprint (and green energy) via more efficient energy conversion and circuit implementations supporting same.

As discussed herein, a fabricator produces one or more assemblies to provide higher density circuitry than provided by conventional instantiation of circuitry on planar circuit boards.

More specifically, this disclosure includes an apparatus, systems, methods, etc. The apparatus can be configured to include a power converter assembly comprising: a stack of multiple circuit layers; multiple transformer windings disposed in the stack of multiple circuit layers, the multiple transformer windings including one or more primary windings and one or more secondary windings; and a first connectivity interface operative to connect the stack of multiple circuit layers to a substrate. The first connectivity interface may be disposed on a first surface of the stack of multiple circuit layers. The first surface is disposed substantially orthogonal to the multiple circuit layers of the stack for beneficial connectivity.

In one example, the multiple transformer windings in the stack include multiple primary windings and multiple secondary windings. Nodes of the multiple secondary windings in the stack may terminate at the first surface of the stack. Nodes of the multiple primary windings may terminate at a second surface of the power converter assembly. The second surface may be disposed on the stack opposite the first surface.

As further discussed during, the multiple transformer windings may be disposed between the multiple circuit layers in the stack.

Yet further, the apparatus as discussed herein may include both the power converter assembly and a host substrate. If desired, the first connectivity interface of the power converter assembly may be directly coupled to a first planar surface region of the host substrate. The multiple circuit layers in the stack may be disposed orthogonal to the first planar surface region of the host substrate to which the first connectivity interface of the power converter assembly is directly or indirectly coupled. As previously discussed, the multiple transformer windings in the stack include primary windings and secondary windings. The secondary windings in the stack may be configured to collectively output an output voltage to power a load. If desired, the load may be directly coupled to a second planar surface region of the host substrate. The second planar surface region of the host substrate may be disposed opposite the first planar surface region of the host substrate such that the host substrate is disposed between the load and the power converter assembly including multiple circuit layers.

In accordance with still further examples, as previously discussed, the multiple transformer windings may include primary windings and secondary windings. The apparatus may further include an interposer substrate (a.k.a., intermediate substrate) disposed between the first connectivity interface of the power converter assembly and a first planar surface of the host substrate. In such an instance, the power converter assembly is in directly coupled to the surface of the host substrate. The interposer substrate (a.k.a., distribution board) can be configured to include first circuit paths connecting axial ends or nodes of the multiple secondary windings in the stack to first nodes disposed on the first planar surface (such as bottom surface) of the host substrate. In such an instance, the first nodes may be disposed on the first planar surface of the host substrate and aligned with second nodes disposed on a second planar surface of the host substrate. The second planar surface of the host substrate may be disposed opposite the first planar surface of the host substrate. The second circuit paths may be disposed in the host substrate provide connectivity between the first nodes disposed on the first surface of the host substrate to the second nodes disposed on the second surface of the host substrate.

The apparatus as discussed herein may further include a load directly coupled to the second planar surface of the host substrate. The first circuit paths can be configured to convey power received from the power converter assembly to the host substrate. Additionally, the second circuit path of the host substrate can be configured to convey the power received from the first circuit paths of the interposer (a.k.a., intermediate substrate or distribution board) through the host substrate to power the load.

In still further examples, the power converter assembly as discussed herein can be configured to include one or more magnetically permeable structures extending through the stack of multiple circuit layers. The multiple transformer windings may be wound around the one or more magnetically permeable structures to provide magnetic coupling amongst each other. A respective axial length of each of the magnetically permeable structures may be disposed parallel to a planar surface of the host substrate to which the first connectivity interface is affixed. In such an instance, the multiple circuit layers in the stack are disposed orthogonal (or vertical) to the planar surface (such as in a horizontal plane) of the host substrate.

In yet a further example, alternatively, if desired, the respective axial length of each of the magnetic permeable structures may be disposed orthogonal to a planar surface of the host substrate to which the first connectivity interface is affixed. In such an instance, the multiple circuit layers of the stack are disposed parallel to the planar surface of the host substrate.

As previously discussed, the multiple transformer windings may include secondary windings magnetically or inductively coupled to corresponding primary windings. Note that the power converter assembly can be configured to include first switch circuitry such as one or more switches operative to control respective current through the primary windings. Stack of multiple layers may further include a second surface disposed opposite the first surface. The first switch circuitry may be disposed in the power converter assembly nearer the second surface of the stack of multiple circuit layers than the first surface.

Still further, the power converter assembly as discussed herein can be configured to include second switch circuitry operative to control respective current through the secondary windings. The second circuitry may be located in the power converter assembly nearer the first surface of the stack of multiple circuit layers than the second surface.

Note further that the apparatus as discussed herein can be configured to include the host substrate (first circuit board) as well as a second circuit board. The power converter assembly may be disposed between the second circuit board and the host substrate. Additionally, in one arrangement, the host substrate is disposed between a load such as electronic circuitry and the power converter assembly. The load may be coupled to the host substrate; the load may be powered by the power converter assembly via power conveyed from the power converter assembly through the host substrate to the load.

Still further examples of the apparatus as discussed herein include a second connectivity interface disposed on a second surface of the stack of multiple circuit layers. The second surface may be disposed opposite the first surface of the stack of multiple circuit layers. The power converter assembly can be configured to convert a DC input voltage received from the second connectivity interface into a DC output voltage outputted from the first connectivity interface of the power converter assembly.

In yet another example, the multiple circuit layers in the stack include any number of circuit layers such as a first circuit board layer and a second circuit board layer. The multiple circuit layers in the stack may include a first circuit board layer and a second circuit board layer. A first terminal of a first secondary winding of the multiple transformer windings may be connected to a first circuit board edge node disposed on an edge of the first circuit board layer; and a first terminal of a second secondary winding of the multiple transformer windings may be connected to a second circuit board edge node disposed on an edge of the second circuit board layer. The first circuit board edge node may align with the second circuit board edge node.

Yet further examples herein include a method of fabricating a power converter assembly, the method comprising: fabricating a power converter assembly to include a stack of multiple circuit layers, the stack of multiple circuit layers including multiple transformer windings, the multiple transformer windings including one or more primary windings and one or more secondary windings; and fabricating the stack of multiple circuit layers to include a first connectivity interface operative to connect the stack of multiple circuit board layers to a host substrate, the first connectivity interface disposed on a first surface of the power converter assembly.

Note that this disclosure includes useful techniques. For example, in contrast to conventional techniques, the novel circuit as discussed herein provides a way to fabricate high density circuitry to provide power to a load.

Note further that any of the resources as discussed herein can include one or more computerized devices, apparatus, hardware, etc., execute and/or support any or all of the method operations disclosed herein. In other words, one or more computerized devices or processors can be programmed and/or configured to operate as explained herein to carry out the different techniques as described herein.

Other aspects of the present disclosure include software programs and/or respective hardware to perform any of the operations summarized above and disclosed in detail below.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of techniques herein (BRIEF DESCRIPTION) purposefully does not specify every novel aspect of the present disclosure or claimed invention(s). Instead, this brief description only presents general aspects and corresponding points of novelty over conventional techniques. For additional details and/or possible perspectives (permutations) of the invention(s), the reader is directed to the Detailed Description section (which is a summary) and corresponding figures of the present disclosure as further discussed below.

### BRIEF DESCRIPTION OF THE DRAWINGS

FIG. 1 is an example diagram illustrating a power converter circuit including a power converter assembly as discussed herein.

FIG. 2A and FIG. 2B are example diagrams illustrating fabrication of a power converter assembly as discussed herein.

FIG. 3 is an example diagram illustrating multiple primary windings disposed in respective circuit layers of the power converter assembly as discussed herein.

FIG. 4 is an example diagram illustrating multiple secondary windings disposed in circuit layers of the power converter assembly as discussed herein.

FIG. 5 is an example diagram illustrating flow of magnetic flux in a power converter assembly as discussed herein.

FIG. 6 is an example diagram illustrating controlled flow of current through respective primary windings and secondary windings of the power converter assembly as discussed herein.

FIG. 7 is an example diagram illustrating different views of a respective power converter assembly as discussed herein.

FIG. 8 is an example diagram illustrating implementation of multiple arrays of the power converter assembly to produce an output voltage to power load as discussed herein.

FIG. 9 is an example diagram illustrating a footprint of implementing multiple power converter assemblies as discussed herein.

FIG. 10 is an example diagram illustrating a power converter circuit as discussed herein.

FIG. 11A and FIG. 11B are example diagrams illustrating fabrication of a power converter assembly as discussed herein.

FIGS. 12A and 12B are example diagrams illustrating controlled flow of current through respective windings of the power converter assembly as discussed herein.

FIG. 13 is an example diagram illustrating a fabrication method as discussed herein.

FIG. 14 is an example side view diagram illustrating implementation of a respective power converter assembly providing power to the load disposed on a mother board as discussed herein.

FIG. 15 is an example side view diagram illustrating multiple surface pads disposed on an edge of a multilayer assembly for coupling to a corresponding host substrate as discussed herein.

The foregoing and other objects, features, and advantages of the disclosed matter herein will be apparent from the following more particular description herein, as illustrated in the accompanying drawings in which like reference characters refer to the same parts throughout the different views. The drawings are not necessarily to scale, with emphasis instead being placed upon illustrating the principles, concepts, aspects, techniques, etc.

### DETAILED DESCRIPTION

As previously discussed, this disclosure is useful over conventional techniques. For example, in contrast to conventional techniques, the novel assemblies as discussed herein support fabrication of high density circuits (such as power converter circuits).

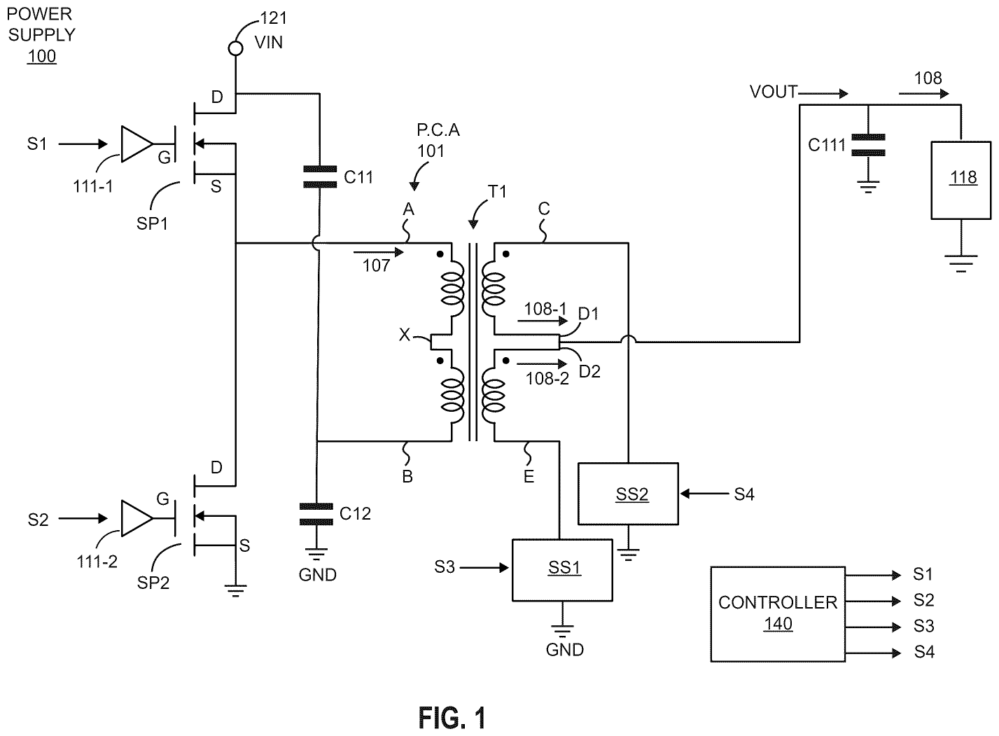

Now, more specifically, FIG. 1 is an example diagram illustrating a power converter circuit as discussed herein.

As shown in FIG. 1, the power supply 101 (such as a DC to DC power converter) includes controller 140, switch driver 111-1, switch driver 111-2, switch SP1, switch SP2, capacitors C11, capacitor C12, transformer T1, switch SS1, switch SS2, output capacitor C111, and load 118. The power converter assembly 101 includes the corresponding transformer T1.

The capacitor C11 and the capacitor C12 are disposed in series between the input voltage source 121 and the ground reference voltage (potential). Node B of the transformer T1 is connected to the circuit path connecting the capacitor C11 to the capacitor C12 in series.

As further shown, the switch SP1 is disposed in series with switch SP2 between the input voltage source 121 and the ground reference voltage GND. For example, the drain (D) node of switch SP1 (such as a field effect transistor or other suitable entity) is connected to the input voltage source 121; the source node(S) of the switch SP1 is connected to the drain node (D) of the switch SP2 (such as a field effect transistor or other suitable entity); the source node(S) of the switch SP2 is connected to the ground reference voltage (GND). Additionally, the source node(S) of the switch SP1 and the drain node (D) of the switch SP2 are both connected to the node A of the transformer T1.

The transformer T1 includes a corresponding first primary winding (such as implemented via one or more windings in parallel) disposed between the node A and node X as well as a second primary winding (such as implemented via one or more windings in parallel) disposed between the node X and node B. The transformer T1 also includes a first secondary winding (such as implemented via one or more windings in parallel) disposed between the node C and node D1. The transformer T1 also includes a second secondary winding (such as implemented via one or more windings in parallel) disposed between the node D2 and node E.

The combination of primary windings of the transformer T1 are disposed in series between the node A and the node B. The combination of secondary windings of the transformer T1 are disposed in series between the node C and node E.

Further, the secondary windings of the transformer T1 are magnetically or inductively coupled to the primary winding of transformer T1. Each of the center nodes D1 and D2 produces a respective output voltage (Vout) to power the corresponding load 118.

In this example, the controller 140 generates corresponding signal S1, S2, S3, and 4. The signal S1 controls operation of switch SP1; the signal S2 controls operation of switch SP2; the signal S3 controls operation of switch SS1; the signal S4 controls operation of the switch SS2.

Based on appropriate switching of the switches SP1, SP2, SS1, and SS2, the power converter assembly 101 converts the input voltage Vin (such as DC input voltage) into the respective output voltage Vout (such as a DC output voltage) and output current 108 to power the corresponding load 118.

More specifically, during power conversion operation, switching of the switches SP1 and SP2 via controller 140 controls a flow of current 107 through the primary windings of the transformer T1, resulting in conveyance of energy from the primary windings disposed in series between node A and node B to the secondary windings of the transformer T1. The switching of the switches SS1 and SS2 control conveyance of output current 108 and output voltage Vout from the secondary windings and the node D (such as center tap node or node of the corresponding transformer T1 providing serial connectivity of the secondary windings) to the load 118 and corresponding output capacitor C111.

Thus, the power supply 100 illustrates conversion of an input voltage Vin such as 48 volts DC or other suitable magnitude into a corresponding output voltage Vout such as one volt DC or other suitable magnitude.

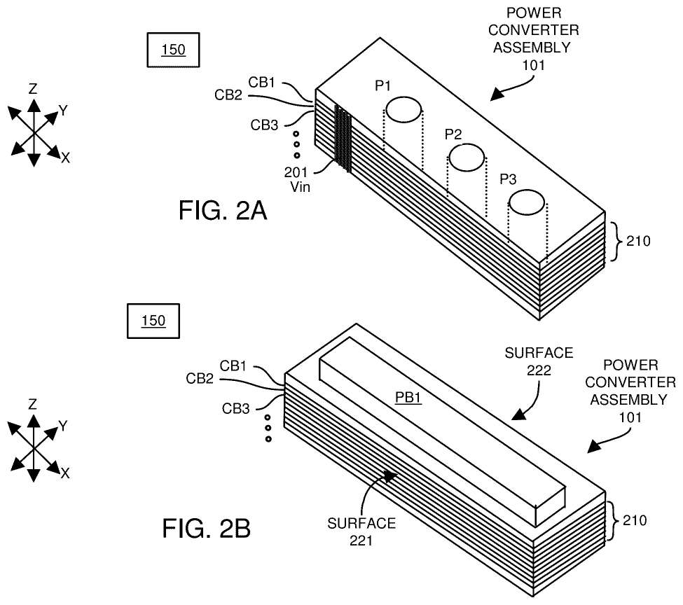

FIG. 2A and FIG. 2B are example diagrams illustrating fabrication of a power converter assembly as discussed herein.

In this example of FIG. 2A, the fabricator 150 produces the power converter assembly 101 to include multiple circuit layers 210, each separated by corresponding insulation material. Each of the multiple layers may be or include a layer of electrically conductive material such as metal as well as the layer of insulation material such as circuit board. The combination of the electrically conductive material (separated by insulation material) associated with the multiple different circuit layers 210 forms the windings of the transformer T1.

As further shown, the power converter assembly 101 includes multiple cores (such as power or other suitable shape) of magnetically permeable material (P1, P2, P3) extending through the stack of multiple circuit layers 210. For example, the power converter assembly 101 includes magnetically permeable material P1 extending axially along the z-axis through each of the multiple circuit layers 210; the power converter assembly 101 includes magnetically permeable material P2 extending axially along the z-axis through each of the multiple circuit layers 210; the power converter assembly 101 includes magnetically permeable material P3 extending axially along the z-axis through each of the multiple circuit layers 210.

As further shown, the magnetically permeable material P1, magnetically permeable material P2, and magnetically permeable material P3 are disposed in parallel with each other and are spaced apart from each other along the x-axis.

The power converter assembly 101 includes multiple circuit layers 210 stacked up along a z-axis. It is noted that the power converter assembly 101 and corresponding multiple circuit layers 210 can include any number of circuit layers; each of the planar shaped circuit layers disposed in the X-Y plane. For example, the power converter assembly 101 includes stack of circuit layers 210 including circuit layer CB1 such as a first circuit board layer and corresponding electrically conductive material, circuit layer CB2 such as a second circuit board layer and corresponding electrically conductive material, circuit layer CD3 such as a third circuit board layer and corresponding electrically conductive material, and so on.

FIG. 2B illustrates further fabrication of the power converter assembly 101 to include the bar of magnetically permeable material PB1 in contact with each of the pillars of magnetically permeable material P1, P2, and P3. As shown in other views, note that the power converter assembly 101 further includes a respective bar of magnetically permeable material PB2 on the bottom side of the power converter assembly 101 as well. Each of the top surfaces associated with the magnetically permeable material P1, P2, P3, may be in contact with the magnetically permeable material PB 1. Each of the bottom surfaces associated with the magnetically permeable material P1, P2, P3, may be in contact with the magnetically permeable material PB2 of the power converter summit 101. Accordingly, the stack of multiple circuit layers 210 associated with the power converter assembly are disposed or sandwiched in between the bar of magnetically permeable material PB1 and the bar of magnetically permeable material PB2, where the structures of magnetically permeable material P1, P2, and P3 extends through each of the multiple circuit layers 210.

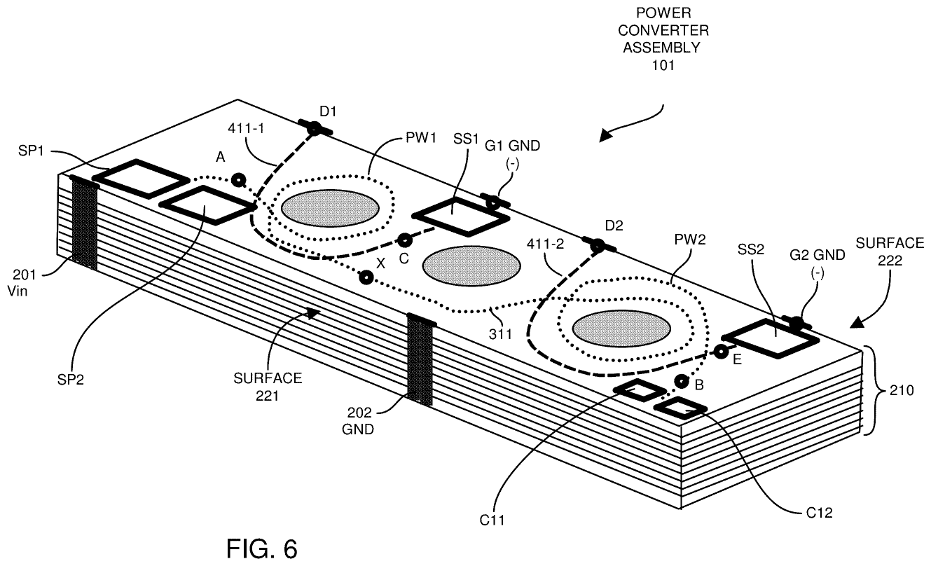

As further discussed herein such as in FIG. 6, each of the bars of magnetically permeable material provide a path in which to support flow of magnetic flux generated as a result of current flowing through the respective primary winding of the transformer T1 between the node A and the node B.

Yet further, note that the power converter assembly 101 in FIG. 2B includes a first surface 221 as well as a second surface 222. The surface 222 is disposed on the stack of multiple circuit layers opposite the first surface 221. The first surface 221 can be configured to include a respective first connectivity interface. The second surface 222 can be configured to include a respective second connectivity interface for coupling to one or more components associated with the power supply 100 as further discussed herein.

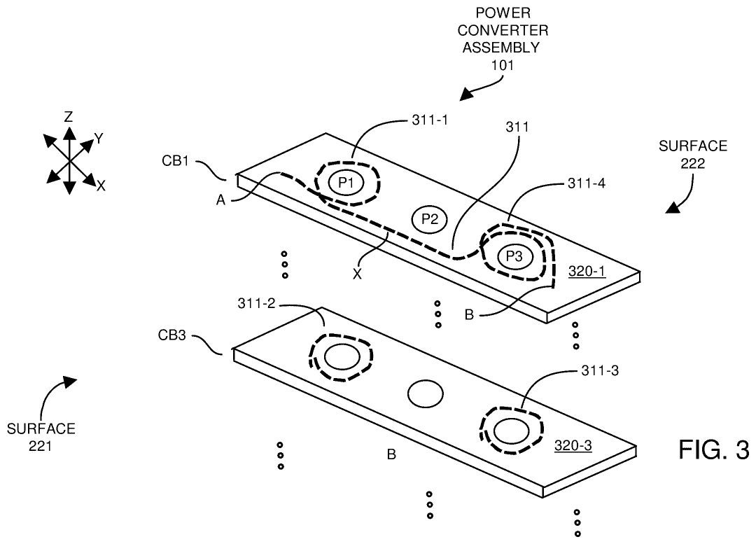

FIG. 3 is an example exploded view diagram illustrating multiple primary windings disposed in respective circuit layers of the power converter assembly as discussed herein.

As previously discussed, the stack of multiple circuit layers 210 (such as circuit boards or other suitable type of component as well as corresponding layers of metal) can be configured to include the first circuit layer CB1, second circuit layer CB2, and so on. The primary windings disposed on one or more of the circuit layers CB1, CB3, CB5, . . . , may be interleaved with respect to one or more secondary windings disposed on circuit layers CB2, CB4, CB6, . . . . Note that any combination of interleaving is possible.

In this example, the first circuit layer CB1 includes a corresponding electrically conductive path 311 (a first primary winding such as one or more turns) disposed on at least a planar substrate 320-1 (non-electrically conductive material or insulator material) in the X-Y plane.

The electrically conductive path 311 associated with one or more the circuit layers extends from the node A counterclockwise around the magnetically permeable material P1 at one or more layers of the stack of layers 210. Note that the electrically conductive path can be configured to wind around the magnetically permeable material P1 one or more times such as via electrically conductive path 311-1 disposed on the substrate 320-1, the electrically conductive path 311-2 disposed on the substrate 320-3 and so on. Accordingly, as previously discussed, the primary winding as implemented by the electrically conductive path 311-1, 311-2, etc., can include any number of turns.

As further shown, after being wrapped counterclockwise around the magnetically permeable material P1 one or more times at the one or more circuit layers such as circuit layer CB1, CB3, etc., the electrically conductive path 311 (such as via electrically conductive path 311-4, electrically conductive path 311-3, etc.) extends to further include one or more clockwise turns around the magnetically permeable material P3 at the one or more circuit layers. After being wrapped around the magnetically permeable material P3 one or more times at the one or more layers, the electrically conductive path 311 finally ends at node B. Node X associated with the electrically conductive path 310 a corresponding transformer T1 corresponds to a midway point between the one or more turns of the electrically conductive path around the magnetically permeable material P1 and the one or more turns of the electrically conductive path around the magnetically permeable material P3.

As previously discussed, the power converter assembly 101 can be configured to include one or more instances of primary windings disposed in parallel, each of the instances implemented at one or more circuit board layers of the power converter assembly 101.

Flow of current through the one or more instances of the corresponding electrically conductive path 311 from node A through node X to node B results in magnetic flux passing through the corresponding magnetically permeable material P1 and P3.

As previously discussed, the second circuit layer CB2 of the stack of layers 210 is disposed between the first circuit layer CB1, third circuit layer CB3, and so on. Thus, the secondary windings at one or more of the circuit layers 210 as further discussed herein can be interleaved in any manner with primary windings disposed at one or more layers of the power converter assembly 101.

As previously discussed, the transformer T1 can include any number of instances of primary windings (such as implemented by the electrically conductive path 311) extending between the node A and the node B.

Additionally, note that the respective electrically conductive paths such as one or more instances of electrically conductive path 311 can take on any shape or thickness.

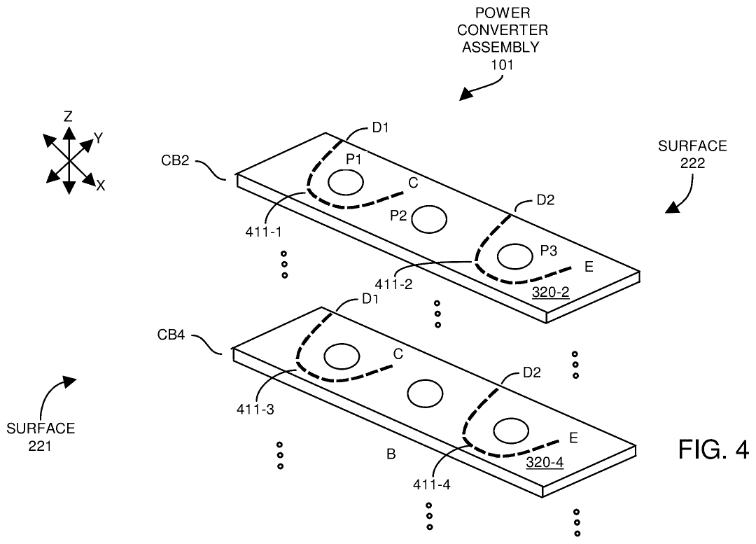

FIG. 4 is an example exploded view diagram illustrating multiple secondary windings disposed in respective circuit layers of the power converter assembly as discussed herein.

In this example, the second circuit layer CB2 includes a corresponding electrically conductive path 411-1 such as a first secondary winding disposed on a planar substrate 320-2 (non-electrically conductive material) of the power converter assembly 101 and corresponding layers in the stack in the X-Y plane. In this example, the electrically conductive path 411-1 extends from the node C counterclockwise around the magnetically permeable material P1, and back to the node D1 disposed on the surface 222 (such as an edge node of the circuit board 320-2) of the power converter assembly 101.

As further shown, the second circuit layer CB2 further includes a corresponding electrically conductive path 411-2 such as a second secondary winding disposed on a planar substrate 320-2 (non-electrically conductive material) in the X-Y plane. The electrically conductive path 411-2 extends from the node E counterclockwise around the magnetically permeable material P3, and back to the node D2 (such as an edge node of the circuit board 320-2) disposed on the surface 222 of the power converter assembly 101.

As further shown, the second circuit layer CB4 further includes a corresponding electrically conductive path 411-3 such as a third secondary winding disposed on a planar substrate 320-4 (non-electrically conductive material) in the X-Y plane. The electrically conductive path 411-3 extends from the node C counterclockwise around the magnetically permeable material P1, and back to the node D1 disposed on the surface 222 (such as an edge node of the circuit board 320-4) of the power converter assembly 101.

As further shown, the second circuit layer CB4 further includes a corresponding electrically conductive path 411-4 such as a fourth secondary winding disposed on a planar substrate 320-4 (non-electrically conductive material) in the X-Y plane. The electrically conductive path 411-4 extends from the node E counterclockwise around the magnetically permeable material P3, and back to the node D2 disposed on the surface 222 (such as an edge node of the circuit board 320-4) of the power converter assembly 101.

Flow of current through the one or more instances of the corresponding electrically conductive paths 311 as previously discussed results in magnetic flux passing through the corresponding magnetically permeable material P1, P2, and P3. Because the secondary windings (one or more instances of the electrically conductive paths 411-1, 411-2, etc., at multiple circuit board layers) are magnetically coupled to the primary windings (one or more instances of the electrically conductive paths 311), the magnetic flux through the magnetically permeable material P1 and magnetic permeable material P3 causes a flow of current through the secondary windings (such as electrically conductive path 411-1, electrically conductive path 411-2, electrically conductive path 411-3, electrically conductive path 411-4, etc.).

More specifically, the one or more parallel secondary windings as implemented via the electrically conductive paths 411-1, 411-3, etc., in the different layers of the power converter assembly 101 produce the output current 108-1 from the node D1 of the power converter assembly 101. The one or more parallel secondary windings as implemented via the electrically conductive paths 411-2, 411-4, etc., in the different layers of the power converter assembly 101 produce the output current 108-2 from the node D2 of the power converter assembly 101. The total output current 108 from the combination of nodes D1 and D2 is a summation of output current 108-1 and output current 108-2.

As previously discussed, the second circuit layer CB2 is disposed between the first circuit layer CB1 and third circuit layer CB3; the fourth circuit layer CB4 is disposed between the third circuit layer CB3 and the fifth circuit layer CB5; and so on.

As previously discussed, the power converter assembly can be configured to include any number of circuit layers including corresponding secondary windings. Additionally, note that the respective electrically conductive paths such as electrically conductive path 411-1, 411-2, 411-3, 411-4, etc., can take on any shape or thickness.

Referring again to FIG. 1, as previously discussed, the controller 140 controls flow of current 107 supplied to the node A and through each of the combination of one or more instances of primary windings in the power converter assembly 101. For example, as previously discussed, at the input side of the power converter assembly 101, the controller 140 controls operation of the switch SP1 and the switch SP2.

Further, at the output side of the power converter assembly 101, the controller 140 controls operation of the switch SS1 and the switch SS2 and thus combination of corresponding current through the electrically conductive paths 411 (secondary windings) such as electrically conductive path 411-1, electrically conductive path 411-2, electrically conductive path 411-3, electrically conductive path 411-4, and so on, to produce the respective output current 108 and output voltage Vout powering the load 118.

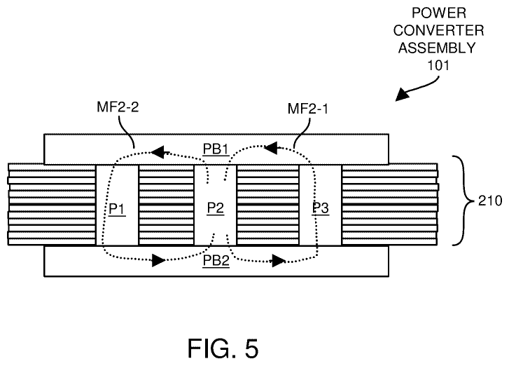

FIG. 5 is an example side view diagram illustrating flow of magnetic flux in a power converter assembly as discussed herein.

As previously discussed, the flow of current 107 through the primary windings of the transformer T1 results in generation of magnetic flux MF2-1 that passes through the magnetically permeable material P3, magnetically permeable material PB1, magnetically permeable material P2, and magnetically permeable material PB2 in a manner shown in FIG. 5.

The flow of current 107 through the primary windings of the transformer T1 also results in generation of magnetic flux MF2-2 that passes through the magnetically permeable material P1, magnetically permeable material PB1, magnetically permeable material P2, and magnetically permeable material PB2 in a manner shown in FIG. 5. The combination of flux may cancel in the magnetically permeable material P2

FIG. 6 is an example diagram illustrating control flow of current through respective windings of the power converter assembly as discussed herein.

As previously discussed, the controller 140 controls flow of current 107 supplied to the node A and through the parallel combination of one or more instances of electrically conductive path 311 (serial connectivity of one or more primary windings) in the power converter assembly 101. For example, as previously discussed, at the input side of the power supply 100, the controller 140 controls operation of the switch SP1 and the switch SP2. In this example, the switches SP1 and SP2 as well as corresponding capacitors C11 and C12 are located in or on the power converter assembly 101 itself. The node A and node B reside internal with respect to the surface 221 of the power converter assembly 101. The power converter assembly receives the input voltage Vin and corresponding ground reference (GND) from any suitable entity. For example, the power converter assembly 101 can be configured to receive the ground reference potential from the surface 222 and convey it through the power converter assembly 101 to the node 202 disposed on the surface 221 of the power converter assembly 101. The power converter assembly 101 can be configured to receive the input voltage from the node 201 disposed on the surface 221. Alternatively, the power converter summit 101 can be configured to receive the input voltage from the surface 222. The one or more layers in the power converter assembly 101 can be configured to convey the input voltage to the switch SP1. The one or more layers in the power converter semiconductor configured to convey the ground reference voltage to the switch SP2. Additional circuit paths in the power converter assembly 101 by connectivity of the switch SP1 in series with the switch SP2.

Further, the power converter assembly 101 can be configured to include the switches SS1 and SS2 at the output side of the power converter assembly 101. In a manner as previously discussed, the controller 140 controls operation of the switch SS1 and the switch SS2 and corresponding current 108-1 and 108-2 through the one or more instances of the electrically conductive paths 411-1 and 411-2 (secondary windings) to produce the respective output voltage Vout and current 108 powering the load 118.

More specifically, the node D1 may be a first surface pad disposed on the surface 222 (edges of circuit layer CB2, circuit layer CB4, circuit layer CB6, etc.) for connectivity of the power converter assembly 101 to another component such as a host circuit board substrate as further discussed herein. The node D1 outputs the output voltage Vout and output current 108-1. As previously discussed, the node D1 (such as common node or surface pad disposed on one or more edges of the circuit boards associated with the power converter assembly 101) can be configured to output the output voltage Vout and corresponding output current 108-1.

The node D2 may be a second surface pad disposed on the surface 222 (edges of circuit layer CB2, circuit layer CB4, circuit layer CB6, etc.) for connectivity of the power converter assembly 101 to another component such as a host circuit board substrate. The node D2 outputs the output voltage Vout and corresponding output current 108-2. Thus, as previously discussed, the node D2 (such as common node or surface pad disposed on edges of the circuit boards associated with the power converter assembly 101) can be configured to output the output voltage Vout and corresponding output current 108-2.

In one example, when the power converter assembly 101 is connected to a corresponding substrate such as a motherboard, interposer, etc., the node D1 is electrically connected to the node D2 via one or more electrically conductive path of the host substrate or interposing connecting node D1 and no D2. Otherwise, the node D1 and D2 may be electrically isolated from each other. Presence of the node D1 as a first surface pad and node D2 as a second surface pad of the power converter assembly provides an ability to provide direct connectivity of the output nodes D1 and D2 of the secondary windings in the power converter assembly 101 to the substrate and/or corresponding load. As further discussed herein, multiple instants of the power converter assembly 101 can be operated in parallel to provide corresponding output current and an output voltage to a load.

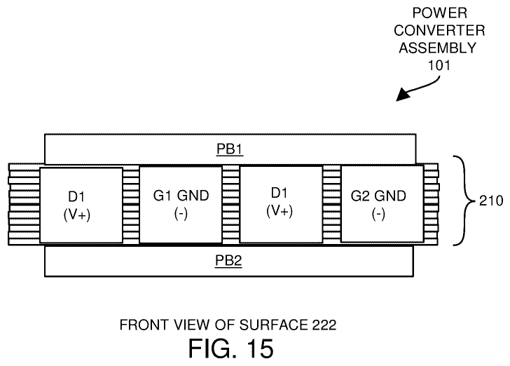

FIG. 15 is an example side view diagram illustrating multiple surface pads disposed on an edge of a multilayer assembly for coupling to a corresponding host substrate as discussed herein.

As shown in this example, and as previously discussed, the front surface 222 of the power converter assembly 101 as shown in FIG. 15 is broken up into blocks or surface pads such as V+ (such as surface pad D1, surface pad D2) and Vgnd (such as surface pad G1, surface G2, etc.). Each of the nodes D1, D2, G1, G2, etc., disposed on the edge of the power converter assembly 101 is connected to a respective one or more layers of circuit boards 210 as previously discussed. The corresponding nodes on surface 222 are finally soldered to a host circuit board. In one example, the surface associated with each of the nodes (fabricated from metal as previously discussed) may be copper etched to provide good soldering to a corresponding host circuit board to which it is affixed.

Accordingly, it should be noted that the corresponding nodes V+ and Vgnd such as surface nodes D1, D2, G1, G2, etc., can be etched. The etching of these exposed surface nodes D1, D2, G1, G2, etc., on the edge of the power converter assembly 101 makes it excellent for soldering the power converter assembly 101 and the corresponding nodes to any corresponding host substrate to which the power converter assembly 101 is affixed.

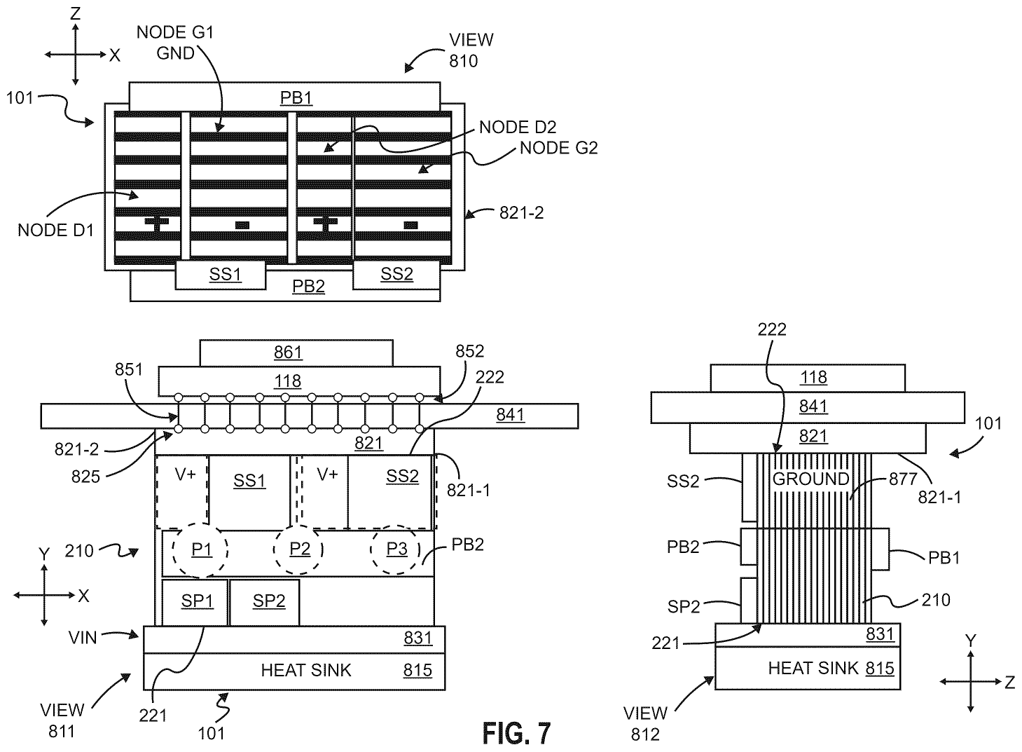

FIG. 7 is an example diagram illustrating different views of a respective power converter assembly as discussed herein.

As shown in FIG. 7, the power converter assembly 101 can be configured to include a combination of the multiple circuit layers 210, magnetically permeable material such as magnetically permeable material PB1, magnetically permeable material PB2, magnetically permeable material P1, magnetically permeable material P2, magnetically permeable material P3, switch SP1, switch SP2, switch SS1, and switch SS2. The power converter assembly 101 further can include the substrate 821. The surface 222 of the power converter assembly 101 (such as including node D1 and node D2) can be directly coupled to the surface 821-1 of the substrate 821. The surface 821-2 of the substrate 821 can be directly coupled to the bottom surface of the substrate 841.

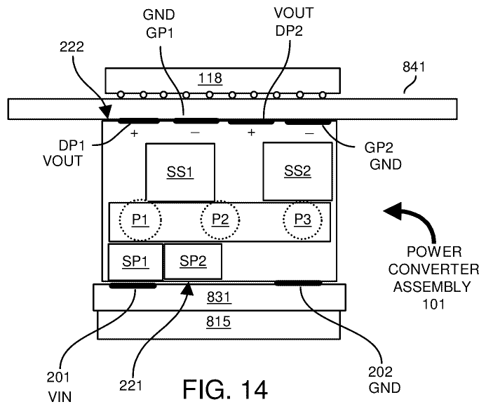

More specifically, as shown in view 811 (bottom left of FIG. 7), the surface 222 of the power converter assembly 101 can be coupled to the surface 821-1 of the substrate 821. In such an instance, when the substrate 821 (such as an interposer board or distribution board) is present, the substrate 821 is disposed between the surface 222 of the power converter assembly 101 and the substrate 841. When the substrate 821 is not present, as shown in FIG. 14, the surface 222 of the power converter assembly 101 is directly coupled to the substrate 841. In such an instance, the substrate 841 is disposed between the load 118 and the surface 222 of the power converter assembly 101.

Referring again to FIG. 7 and corresponding view 811, the load 118 such as electronic circuitry (such as a microprocessor or other electronic circuitry) may be affixed to the corresponding substrate 841 via the electrically conductive nodes 852 (such as surface pads, solder balls, etc.).

The substrate 841 can be configured to include surface pads as well as corresponding electrically conductive paths 851 providing connectivity between the conductive nodes 825 (such as surface pads, solder balls, etc.) disposed on the surface 821-2 of the substrate 821 and the corresponding electrically conductive nodes 852 of the load 118.

To simplify routing of the corresponding output voltage, ground reference voltage, or other signals conveyed from the power converter assembly 101 to the load 118 or substrate 841, the combination of the nodes 825, electrically conductive paths with 851, and the electrically conductive nodes 852 can be configured to be aligned with each other in the y-axis. In such an instance, the substrate or interposer 821 is a so-called distribution board providing electrically conductive paths and appropriate circuit routing between the power converter assembly 101 and the substrate 841.

Note that the electrically conductive paths 851 can be configured to convey any signals such as ground, output voltage Vout, etc., from the power converter assembly 101 and/or substrate 841 to the load 118 or vice versa. One or more additional circuit paths in the substrate 821 can be configured to convey the ground reference voltage from the substrate 841 to the power converter assembly 101. Additionally, note that the power converter assembly can be configured to receive the input voltage at or via the substrate 831 if desired. In such an instance, the substrate 831 provides the input voltage to the power converter assembly 101. Additionally or alternatively, the power converter assembly 101 can be configured to receive the input voltage from the substrate 841 through the substrate 821.

As further shown, the heatsink 815 is affixed to the substrate 831 to provide dissipation of heat associated with the power converter assembly 101.

As previously discussed, the power converter assembly 101 includes the surface 222. The surface 222 can be directly coupled to the surface 821-1 of the substrate 821. View 810 (top left in FIG. 7) illustrates the surface 821-1 of the substrate 821. In one example, via the connectivity of the surface 222 to the substrate 821, the substrate 821 receives the generated output voltage (such as via node D1 and node D2). Via one or more electrically conductive paths in the substrate 821, the substrate 821 conveys the generated output voltage and/or the ground reference to the surface nodes disposed on the surface 821-2 of the substrate 821. In this example, thus, each + box (Vout) or − box (ground) is copper etched on the outside surface pad of the power converter assembly 101 to provide connectivity of the respective nodes such as node D1, node D2, node G1, node G2, etc., of the power converter assembly 101 to the substrate 841 or substrate 821. In one example, the substrate 841 provides the ground reference voltage to the power converter assembly through the ground node G1 and ground node G2 (see FIG. 6 and corresponding surface pad G1 and surface pad G2 disposed on surface 222 of the power converter 101).

Referring again to FIG. 7, alternatively, note that the substrate 821 may not be included in the power converter assembly 101. In such an instance, the surface 222 of the power converter assembly 101 can be directly connected to corresponding nodes (825) on the bottom side (surface) of the substrate 841. In other words, if desired, the first connectivity interface such as surface 222 of the power converter assembly 101 may be directly coupled to a first planar surface region of the host substrate 841 (see FIG. 14). The multiple circuit layers 210 in the stack may be disposed orthogonal to the first planar surface region of the host substrate 841 to which the surface 222 of the power converter assembly is directly coupled.

Further, in this example in FIG. 7, note that the load 118 is directly coupled to a planar surface region of the host substrate 841. The planar surface region of the host substrate 841 to which the load 118 is affixed is disposed opposite a planar surface region of the host substrate 841 to which the substrate 821 is affixed. In such an instance, the host substrate 841 is disposed between the load 118 and the corresponding combination of the substrate 821 and the power converter assembly 101.

As previously discussed, the substrate 821 such as an interposer substrate or intermediate circuit board may be disposed between the first connectivity interface (such as surface 222) of the power converter assembly 101 and a first planar surface of the host substrate 841. Further, as previously discussed, the substrate 821 includes electrically conductive circuit paths connecting axial or terminal ends of the multiple secondary windings (such as nodes D1, D2, etc.) in the stack to nodes 825 disposed on the first planar surface of the host substrate 841. As previously discussed, the nodes (825) disposed on the planar surface of the host substrate 841 may be aligned with second nodes (852) disposed on a second planar surface of the host substrate 841. As previously discussed, the electrically conductive circuit paths 851 in the host substrate 841 provide connectivity between the first nodes 825 disposed on the host substrate 841 to second nodes 852 disposed on a second surface of the host substrate 841 supporting connectivity to the load 118.

As shown in view 812 (bottom right of FIG. 7), the multiple circuit layers 210 in the stack are disposed orthogonal to the planar surface of the substrate 841 and the substrate 821. As previously discussed, the power converter assembly 101 can be configured to include first switch circuitry such as switch SP1 and switch SP2 operative to control respective current through the primary windings of the transformer T1. The switches SP1 and switch SP2 are disposed nearer to the surface 221 of the power converter assembly 101 than the surface 222.

Further, as shown in view 812, as well as previously discussed, the power converter assembly 101 includes switch circuitry such as switch SS2 and switch SS1 that control respective current through the secondary windings of the transformer T1. The switch SS1 and switch SS2 are disposed nearer the surface 222 of the power converter assembly 101 than the surface 221 of the power converter assembly 101.

As further shown, the power converter assembly 101 may be disposed between the substrate 831 and the substrate 841. The substrate 841 may be disposed between the load 118 and the power converter assembly 101.

The magnetically permeable structures such as magnetically permeable material P1, magnetically permeable material P2, magnetically permeable material P3 extend through the stack of multiple circuit layers 210 as previously discussed. An axial length (such as along the z-axis) of the magnetically permeable structures is disposed parallel to a planar surface (such as in the X-Z plane) of the host substrate 841 or substrate 821 to which the first connectivity interface (such as surface 222) may be affixed.

Note further that the output capacitors associated with the power supply circuitry as discussed herein such as capacitor C111 (one more capacitors) can be mounted to the substrate 831, any surface of the power converter assembly 101, substrate 821, and/or substrate 841.

FIG. 14 is an example side view diagram illustrating implementation of a respective power converter assembly providing power to the load on a mother board as discussed herein. In this example, the surface 222 of the power converter assembly 101 includes a connection interface comprising surface pad DP1 (also known as node D1), surface pad GP1 (also known as node G1), surface pad DP2 (also known as node D2), surface pad GP2 (also known as node G2). The surface pad DP1 and the surface pad DP2 (such as disposed on the surface 222 and corresponding edges of the multiple circuit layers) both can be configured to receive the output voltage from node(s) D1 and D2 generated at the multiple different circuit layers of the power converter assembly 101. The substrate in 841 can be configured to convey the output voltage Vout and corresponding output currents as 108-1 and 108-2 received for outputted from the surface pad DP1 and surface pad DP2 to the load 118 via one or more electrically conductive paths through the substrate 841. The substrate in 841 can be configured to convey the GND voltage received from the surface pad GP1 and surface pad GP2 to the load 118 via one or more electrically conductive paths through the substrate 841. Alternatively, the substrate 841 can be configured to provide the ground reference potential to the power converter assembly 101 via the corresponding surface pad GP1 and GP2.

As further shown, and as previously discussed, the surface 221 disposed on the power converter substrate 101 can be configured to include a respective surface pad 201 to receive the input voltage from the substrate 831. Additionally, the power converter assembly 101 can be configured to include a respective surface pad 202 to receive the ground voltage from the substrate in 831 or provide the ground reference voltage received from the power converter assembly 101 to the substrate 831. Alternatively, as previously discussed, the power converter assembly can be configured to include additional surface pads disposed on the surface 222 to receive the input voltage and ground signal from the substrate 841. Accordingly, the power converter assembly 101 can be configured to receive the input voltage Vin and GND from any source.

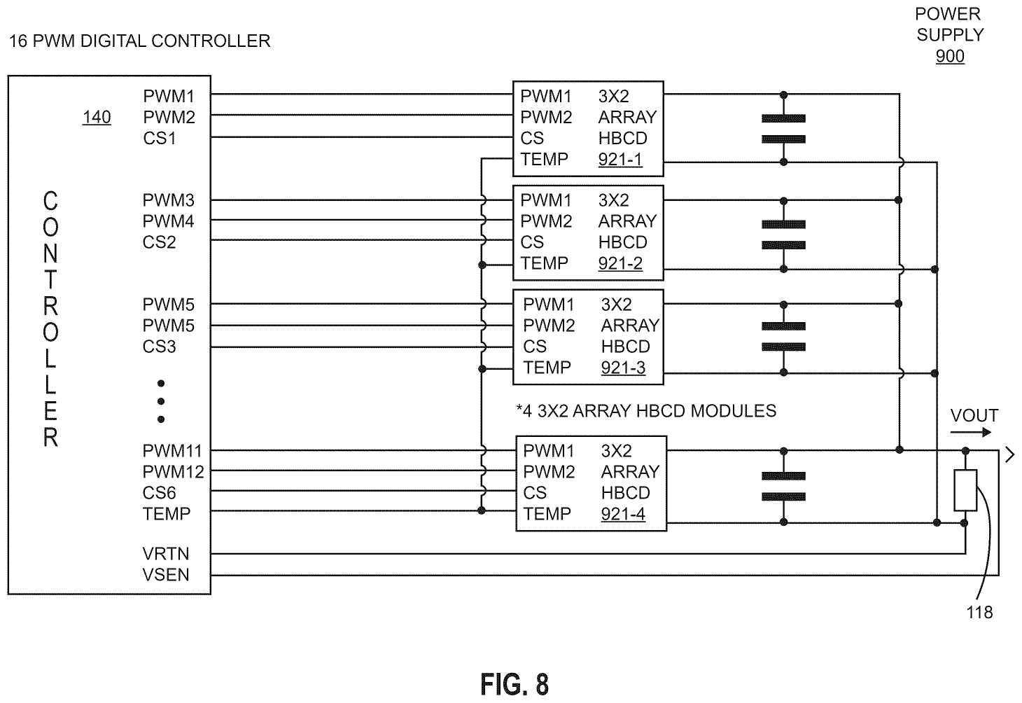

FIG. 8 is an example diagram illustrating implementation of multiple arrays of the power converter assembly to power a load as discussed herein.

Note that multiple instances of the power converter assembly 101 can be implemented to produce an array of power converter assemblies. For example, each instance of the power converter assembly 921-X includes six instances (such as a 3 by 2 matrix) of the power converter assembly 101 disposed in parallel. Yet further, the combination of the power converter assemblies in the power converter assembly 921-X (such as power converter assembly 921-1, power converter assembly 921-2, power converter assembly 921-3, and power converter assembly 921-4) of power supply 900 collectively produce a respective output voltage to power the load 118.

Thus, as shown in FIG. 8, power supply 900 can be configured to include a parallel combination of multiple instances of the power converter array 921 such as power converter array 921-1, power converter array 921-2, power converter array 921-3, and power converter array 921-4 disposed in parallel. In a similar manner as previously discussed, each of the power converter arrays 921 produces the respective output voltage Vout to power the load 118.

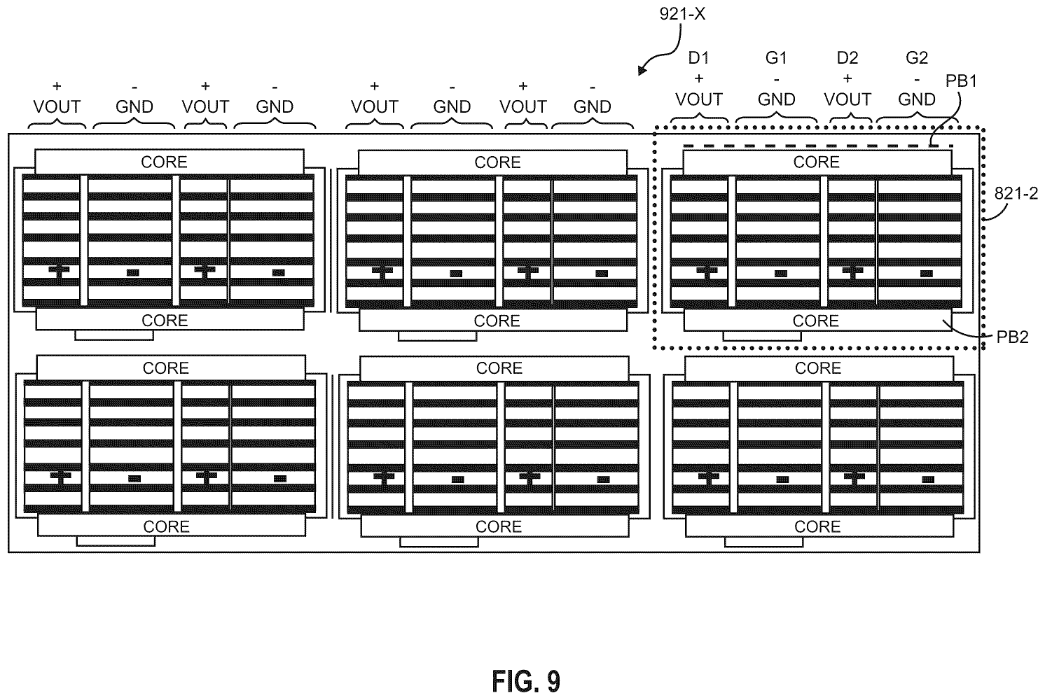

FIG. 9 is an example diagram illustrating a footprint of implementing multiple power converter assemblies as discussed herein.

As previously discussed, a respective surface 821-2 of the power converter assembly 101 associated with the substrate 821 can be configured to include multiple nodes in which to input/output or convey one or more signals such as a respective output voltage Vout, ground reference voltage GND, etc. FIG. 9 illustrates a respective footprint of the power converter array 921-X, where X is a respective instance of the power converter array such as power converter array 921-1, power converter array 921-2, power converter array 921-3, or power converter array 921-4. The plus nodes (+) of the surface 222 of the power converter assembly 101 output the output voltage from respective nodes D1 and D2. The minus nodes (−) of the surface 222 of the power converter assembly 101 received the ground reference voltage from the substrate 841 or the substrate 821.

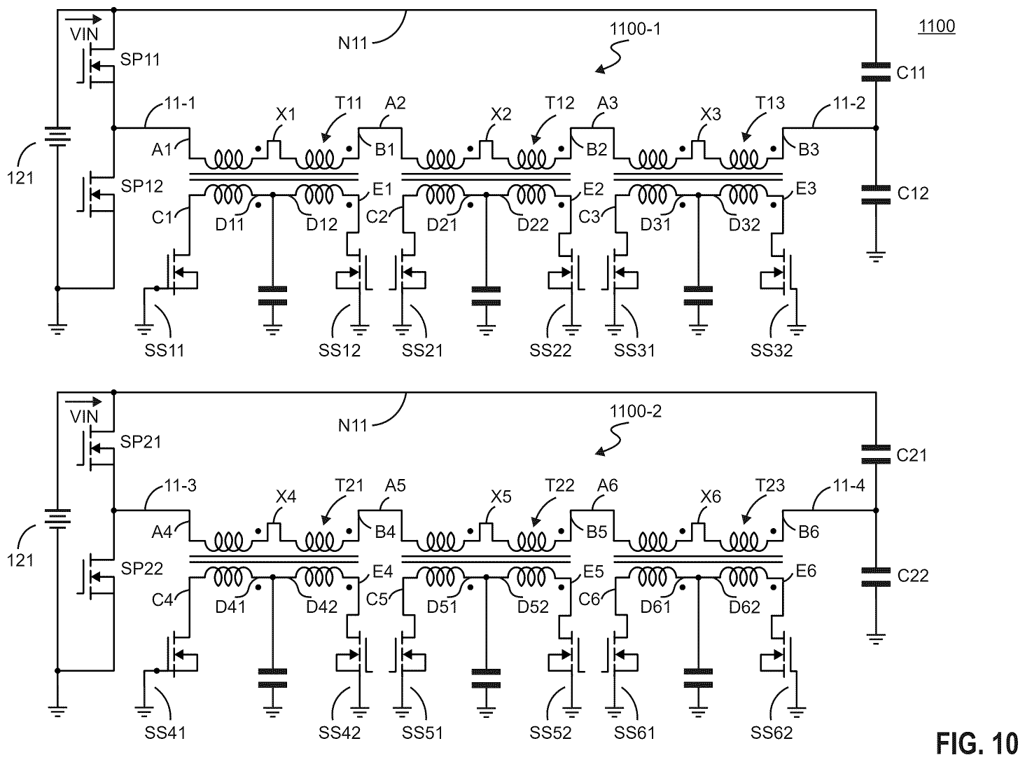

FIG. 10 is an example diagram illustrating a power converter circuit as discussed herein. In this example, the power supply 1100 includes power converter 1100-1 and power converter 1100-2 connected in parallel to produce a respective output voltage the output. In general, each of the power converter 1100-1 and the power converter 1100-2 include multiple instances of the power converter assembly 101. For example, node D11, node D12, node D21, node D22, node D31, node D32, node D41, node D42, node D51, node D52, node D61, and node D62, are all connected to each other and output the respective output voltage Vout.

The power converter 1100-1 includes multiple transformers disposed in series. For example, the power converter 1100-1 includes multiple transformers such as transformer T11, transformer T12, and transformer T13. Transformer T11 includes respective one or more primary windings connected in series between the node A1 and the node B1; the transformer T12 includes one or more primary windings connected in series between the node A2 and the node B2; the transformer T13 includes one or more primary windings connected in series between the node A3 and the node B3.

As shown, the combination of the primary windings associated with the transformer T11, transformer T12, and transformer T13 are connected in series between node 11-1 and node 11-2.

In a similar manner as previously discussed, the switch SP11 is disposed in series with switch SP12 between the node N11 and the ground reference voltage. The switch SP11 is coupled to the switch SP12 via the node 11-1.

The capacitor C11 is disposed in series with capacitor C12 between the node N11 and the ground reference voltage. The capacitor C11 is coupled to the capacitor C12 via the node 11-2.

As further shown, the transformer T11 includes a first secondary winding connected between node C1 and node D11; the transformer T11 further includes a second secondary winding connected between the node E1 and the node D12. As previously discussed, the node D11 and node D12 both output a respective output voltage to power the load 118.

The transformer T12 includes a first secondary winding connected between node C2 and node D21; the transformer T12 further includes a second secondary winding connected between the node E2 and the node D22. As previously discussed, the node D21 and node D22 both output a respective output voltage to power the load 118.

The transformer T13 includes a first secondary winding connected between node C3 and node D31; the transformer T13 further includes a second secondary winding connected between the node E3 and the node D32. As previously discussed, the node D31 and node D32 both output a respective output voltage to power the load 118.

The power supply 1100 further includes the power converter 1100-2, which is similar to power converter 1100-1.

Controller 140-1 controls operations of the switches SP11, SP12, SS11, SS12, SS21, SS22, SS31, and SS32. Controller 140-1 controls operations of the switches SP21, SP22, SS41, SS42, SS51, SS52, SS61, and SS62.

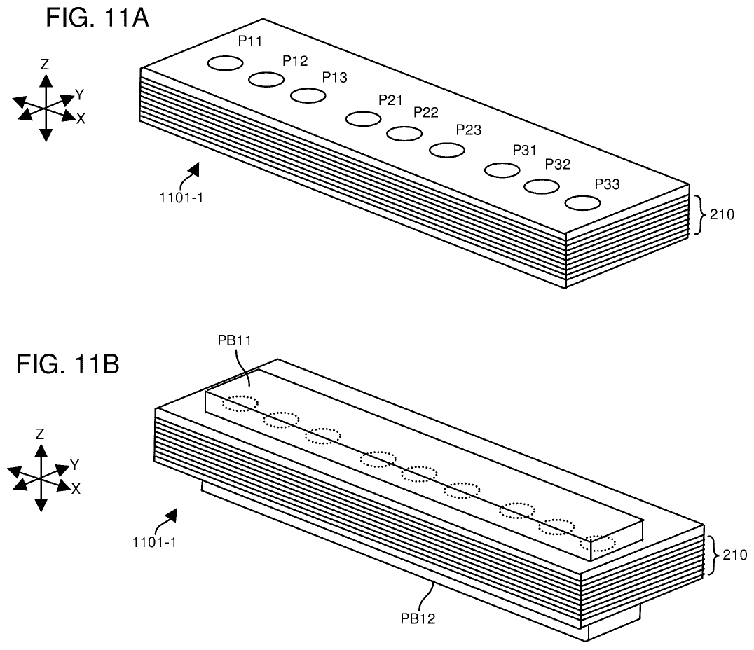

FIG. 11A and FIG. 11B are example diagrams illustrating fabrication of a power converter assembly as discussed herein.

In this example of FIG. 11A, the fabricator 150 produces the power converter assembly 1101-1 to include multiple circuit layers 210 in a similar manner as previously discussed, each separated by corresponding insulation material. Each of the multiple layers may be or include a layer of electrically conductive material such as metal. The combination of the electrically conductive material associated with the multiple different circuit layers 210 forms the windings of the transformer T11, T12, and T13. For example, the power converter assembly 1101 includes 3 instances of the power converter assembly 101 in a single power converter assembly.

As further shown, the power converter assembly 1101 includes multiple cores of magnetically permeable material P11, P12, P13, P21, P22, P23, P31, P32, P33 extending through the stack of multiple circuit layers 210. For example, the power converter assembly 101 includes magnetically permeable material P11 extending axially along the z-axis through the multiple circuit layers 210; the power converter assembly 1101 includes magnetically permeable material P12 extending axially along the z-axis through the multiple circuit layers 210; the power converter assembly 1101 includes magnetically permeable material P13 extending axially along the z-axis through the multiple circuit layers 210.

As further shown, the magnetically permeable material P11, magnetically permeable material P12, and magnetically permeable material P13 are disposed in parallel with each other and are spaced apart from each other along the x-axis.

The magnetically permeable material P21, magnetically permeable material P22, and magnetically permeable material P23 are disposed in parallel with each other and are spaced apart from each other along the x-axis.

The magnetically permeable material P31, magnetically permeable material P32, and magnetically permeable material P33 are disposed in parallel with each other and are spaced apart from each other along the x-axis.

The power converter assembly 1101 includes multiple circuit layers 210 stacked up along a z-axis in a manner as previously discussed. It is noted that the power converter assembly 101 and corresponding multiple circuit layers 210 can include any number of circuit layers; each of the circuit layers disposed in the X-Y plane. Each of the layers 210 includes one or more primary winding and/or secondary winding.

FIG. 11B illustrates further fabrication of the power converter assembly 1101 to include the bar of magnetically permeable material PB11 in contact with each of the pillars of magnetically permeable material P11, P12, P13, P21, P22, P23, P31, P32, and P33. Note that the power converter assembly 1101 further includes a respective bar of magnetically permeable material PB12 on the bottom side of the power converter assembly 1101. Accordingly, the multiple circuit layers 210 are disposed or sandwiched in between the bar of magnetically permeable material PB11 and the bar of magnetically permeable material PB12.

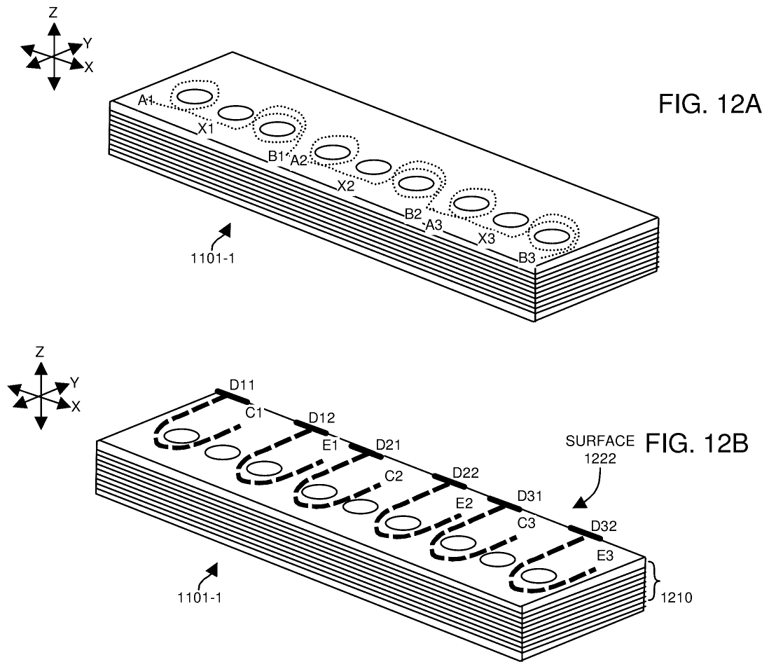

FIGS. 12A and 12B are example diagrams illustrating controlled flow of current through respective windings of the power converter assembly as discussed herein.

In this example, one or more circuit layers of the power converter assembly 1101-1 include primary windings and secondary windings associated with each of the transformers T11, T12, and T13. Each of the transformers operates in a similar manner as previously discussed. However, in this example, the power converter assembly 1101-1 includes a serial connectivity of the respective primary windings. For example, node A1 is connected to node 11-1, the node B1 is connected to the node A2, the node B2 is connected to the node A3, node B3 is connected to node 11-2 in a manner as previously discussed. See FIG. 10 for nodes 11-1 and 11-2. Nodes D11, D12, D21, D22, D31, D32, etc., are connected together to produce the output voltage.

In a similar manner as previously discussed, the power converter assembly 1101-1 can be configured to include one or more secondary windings in one or more of the circuit layers 1210 extending between the node C1 and the node D11. Note further that the node D11 can be configured as a surface pad disposed on the surface 1222, providing good connectivity to a corresponding substrate such as an interposer or a host substrate and a manner as previously discussed.

The power converter assembly 1101-1 can be configured to include one or more secondary windings in one or more of the circuit layers 1210 extending between the node E1 and the node D12. Note further that the node D12 can be configured as a surface pad disposed on the surface 1222, providing good connectivity to a corresponding substrate such as an interposer or a host substrate and a manner as previously discussed.

The power converter assembly 1101-1 can be configured to include one or more secondary windings in one or more of the circuit layers 1210 extending between the node C2 and the node D21. Note further that the node D21 can be configured as a surface pad disposed on the surface 1222, providing good connectivity to a corresponding substrate such as an interposer or a host substrate and a manner as previously discussed.

The power converter assembly 1101-1 can be configured to include one or more secondary windings in one or more of the circuit layers 1210 extending between the node E2 and the node D22. Note further that the node D22 can be configured as a surface pad disposed on the surface 1222, providing good connectivity to a corresponding substrate such as an interposer or a host substrate and a manner as previously discussed.

The power converter assembly 1101-1 can be configured to include one or more secondary windings in one or more of the circuit layers 1210 extending between the node C3 and the node D31. Note further that the node D31 can be configured as a surface pad disposed on the surface 1222, providing good connectivity to a corresponding substrate such as an interposer or a host substrate and a manner as previously discussed.

The power converter assembly 1101-1 can be configured to include one or more secondary windings in one or more of the circuit layers 1210 extending between the node E3 and the node D32. Note further that the node D32 can be configured as a surface pad disposed on the surface 1222, providing good connectivity to a corresponding substrate such as an interposer or a host substrate and a manner as previously discussed.

In a similar manner as previously discussed, note that the surface 1222 may include corresponding ground pads to receive a respective ground reference voltage from the corresponding component to which the surface 1222 is attached. For example, a respective first ground pad may be disposed on the surface 1222 between respective nodes D11 and D12, a second respective ground pad may be disposed on the surface 1222 between respective nodes D12 and D21, a third respective ground pad may be disposed on the surface 1222 between respective nodes D21 and D22, and so on.

Referring again to FIGS. 12A and 12B, note that the power converter assembly 1100-1 is fabricated similar to power converter assembly 1100-2. Again the combination of power converter assembly 1100-1 and power converter assembly 1100-2 is shown in FIG. 11 produce a respective output voltage to power the load.

Referring again to FIG. 11, the controller 140 controls flow of current through the respective primary windings and secondary windings of each of the transformers associated with the power converter assembly 1101-1. In similar manner, the controller 140 controls flow of current through the respective primary windings and secondary windings of each of the transformers associated with the power converter assembly 1101-2.

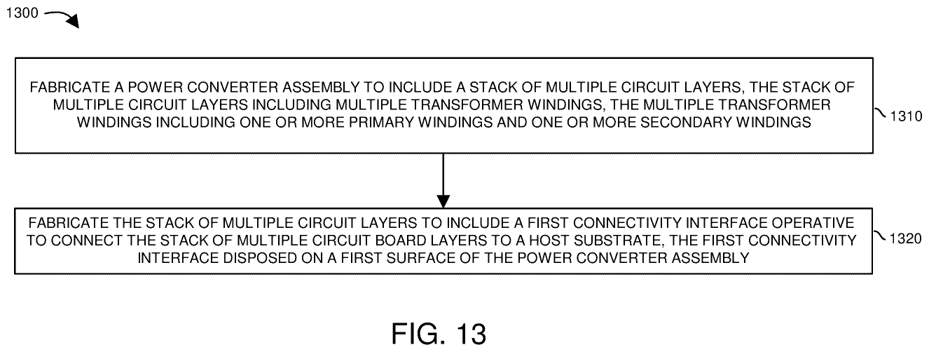

The functionality supported by the different resources will now be discussed via flowchart in FIG. 13. Note that the operations in the flowcharts below can be executed in any suitable order.

FIG. 13 is a flowchart 1400 illustrating an example method as discussed herein. Note that there will be some overlap with respect to concepts as discussed above.

In processing operation 1510, the fabricator 150 fabricates a power converter assembly to include a stack of multiple circuit layers, the stack of multiple circuit layers including multiple transformer windings, the multiple transformer windings including one or more primary windings and one or more secondary windings.

In processing operation 1520, the fabricator 150 fabricates the stack of multiple circuit layers to include a first connectivity interface operative to connect the stack of multiple circuit board layers to a substrate. The first connectivity interface is disposed on a first surface of the power converter assembly.

Note again that techniques herein are well suited for use in circuit assembly applications such as those providing power delivery to one or more loads. However, it should be noted that the disclosure of matter herein is not limited to use in such applications and that the techniques discussed herein are well suited for other applications as well.

While this invention has been particularly shown and described with references to preferred aspects thereof, it will be understood by those skilled in the art that various changes in form and details may be made therein without departing from the spirit and scope of the present application as defined by the appended claims. Such variations are intended to be covered by the scope of this present application. As such, the foregoing description in the present disclosure is not intended to be limiting. Rather, any limitations to the invention are presented in the following claims.

1. An apparatus comprising:
a power converter assembly comprising:
a stack of multiple circuit layers;
multiple transformer windings disposed in the stack of multiple circuit layers, the multiple transformer windings including one or more primary windings and one or more secondary windings; and
a first connectivity interface operative to connect the stack of multiple circuit layers to a host substrate, the first connectivity interface being disposed on a first surface of the stack of multiple circuit layers, wherein the first surface is disposed substantially orthogonal to the multiple circuit layers of the stack.

2. The apparatus as in claim 1, wherein the multiple transformer windings in the stack include multiple primary windings and multiple secondary windings; and
wherein nodes of the multiple secondary windings in the stack extend to the first surface of the stack.

3. The apparatus as in claim 2, wherein the multiple primary windings are magnetically coupled to the secondary windings via magnetically permeable material disposed in the power converter assembly;
wherein a first portion of the magnetically permeable material extends through the stack of multiple circuit layers; and
wherein the multiple circuit layers are disposed between a second portion of the magnetically permeable material and a third portion of the magnetically permeable material.

4. The apparatus as in claim 1, wherein nodes of each of the one or more secondary windings are coupled to the first connectivity interface.

5. The apparatus as in claim 1 further comprising:
the host substrate; and
wherein the first connectivity interface of the power converter assembly is directly coupled to a first planar surface region of the host substrate, the multiple circuit layers in the stack disposed orthogonal to the first planar surface region of the host substrate to which the first connectivity interface of the power converter assembly is directly coupled.

6. The apparatus as in claim 5, wherein the multiple transformer windings in the stack include multiple primary windings and multiple secondary windings; and
wherein the multiple secondary windings in the stack are operative to collectively output an output voltage to power a load, the load directly coupled to a second planar surface region of the host substrate, the second planar surface region of the host substrate disposed opposite the first planar surface region of the host substrate such that the host substrate is disposed between the load and the power converter assembly.

7. The apparatus as in claim 1, wherein the multiple transformer windings include multiple primary windings and multiple secondary windings, the apparatus further comprising:
an interposer substrate disposed between the first connectivity interface of the power converter assembly and a first planar surface of the host substrate, the interposer substrate including first circuit paths, the first circuit paths connecting the multiple secondary windings in the stack to first nodes disposed on the first planar surface of the host substrate.

8. The apparatus as in claim 7, wherein the first nodes disposed on the first planar surface of the host substrate are aligned with second nodes disposed on a second planar surface of the host substrate, the second planar surface of the host substrate being disposed opposite the first planar surface of the host substrate.

9. The apparatus as in claim 8, wherein second circuit paths disposed in the host substrate provide connectivity between the first nodes disposed on the first surface of the host substrate to the second nodes disposed on the second surface of the host substrate.

10. The apparatus as in claim 9 further comprising:
a load directly coupled to the second planar surface of the host substrate, the first circuit paths operative to convey power received from the power converter assembly to the host substrate, the second circuit paths further operative to convey the power received from the first circuit paths through the host substrate to power the load.

11. The apparatus as in claim 1, wherein the power converter assembly includes a magnetically permeable structure extending through the stack of multiple circuit layers, the multiple transformer windings wound around the magnetically permeable structure; and
wherein an axial length of the magnetically permeable structure is disposed parallel to a planar surface of the host substrate to which the first connectivity interface is affixed.

12. The apparatus as in claim 11, wherein the multiple circuit layers in the stack are disposed orthogonal to the planar surface of the host substrate.

13. The apparatus as in claim 1, wherein the multiple transformer windings include multiple primary windings and multiple secondary windings; and
wherein the power converter assembly further comprises: first switch circuitry operative to control respective current through the multiple primary windings, the first circuitry disposed in the power converter assembly nearer a second surface of the stack of multiple circuit layers than the first surface, the second surface being disposed in the power converter assembly opposite the first surface.

14. The apparatus as in claim 13, wherein the power converter assembly further comprises: second switch circuitry operative to control respective current through the multiple secondary windings, the second switch circuitry located in the power converter assembly nearer the first surface of the stack of multiple circuit layers than the second surface.

15. The apparatus as in claim 1 further comprising:
wherein the host substrate is a first circuit board;
a second circuit board; and
wherein the power converter assembly is disposed between the second circuit board and the host substrate.

16. The apparatus as in claim 15, wherein the host substrate is disposed between a load and the power converter assembly;
wherein the load is coupled to the host substrate; and
wherein the power converter assembly is operative to supply power to the load through the host substrate.

17. The apparatus as in claim 1 further comprising:
a second connectivity interface disposed on a second surface of the stack of multiple circuit layers, the second surface disposed opposite the first surface of the stack of multiple circuit layers; and
wherein the power converter assembly is operative to convert a DC input voltage received from the second connectivity interface into a DC output voltage outputted from the first connectivity interface of the power converter assembly, the DC output voltage outputted from secondary windings of the transformer windings.

18. The apparatus as in claim 1, wherein the multiple circuit layers in the stack include a first circuit board layer and a second circuit board layer;
wherein a first terminal of a first secondary winding of the multiple transformer windings is connected to a first circuit board edge node, the first circuit board edge node disposed on an edge of the first circuit board layer; and
wherein a first terminal of a second secondary winding of the multiple transformer windings is connected to a second circuit board edge node, the second circuit board edge node disposed on an edge of the second circuit board layer.

19. The apparatus as in claim 18, wherein the first circuit board edge node aligns with the second circuit board edge node in the stack.

20. A method of fabricating a power converter assembly, the method comprising:
fabricating a power converter assembly to include a stack of multiple circuit layers, the stack of multiple circuit layers including multiple transformer windings, the multiple transformer windings including one or more primary windings and one or more secondary windings; and
fabricating the stack of multiple circuit layers to include a first connectivity interface operative to connect the stack of multiple circuit board layers to a host substrate, the first connectivity interface disposed on a first surface of the power converter assembly.
